(19) United States
(12) Patent Application Publication
(10) Pub. No.: US 2014/0032088 A1
(43) Pub. Date: Jan. 30, 2014

(54) METHOD OF TRAFFIC CONDITION NOTIFICATION AND SYSTEM THEREOF

(71) Applicants: Jui-Yen Chang, Taoyuan County (TW); Yu-Hao Hou, Taipei City (TW); Ming-Feng Chang, Hsinchu City (TW)

(72) Inventors: Jui-Yen Chang, Taoyuan County (TW); Yu-Hao Hou, Taipei City (TW); Ming-Feng Chang, Hsinchu City (TW)

(73) Assignee: Industrial Technology Research Institute, Hsin-Chu (TW)

(21) Appl. No.: 13/559,718

(22) Filed: Jul. 27, 2012

(30) Foreign Application Priority Data
Jul. 26, 2012 (TW) 101126995

(51) Int. Cl. G08G 1/00

(52) U.S. Cl. 701/117

(57) ABSTRACT

A method of traffic condition notification, adapted to a traffic information center, the method has steps are: receiving at least one travel information in a observing period, the travel information includes at least a travel time which had been taken on a predetermined distance; according to at least two travel information, determining a trend; and updating the travel information based on the trend, and broadcasting the new traffic information.

### CROSS REFERENCE TO RELATED APPLICATION

The present application is based on, and claims priority from, Taiwan (International) Application Serial Number 101126995, filed on Jul. 26, 2012, the disclosure of which is hereby incorporated by reference herein in its entirety.

### TECHNICAL FIELD

The present disclosure relates to a traffic condition notification method and system, and more particularly, to a real-time method and system of traffic condition notification.

### TECHNICAL BACKGROUND

In most advance countries, including European countries, America, Japan and Korea, it is common to have a kind of traveler information service built to provide real-time traffic information and the guidance of route so as to assist the road user to make an efficient travel decision.

Most of the traveler information services available today are heavily dependent upon information that are reported or gathered in real time from the global positioning systems (GPS) that are mounted either on public transportation fleets including buses and taxies, or on fixed traffic monitors.

However, it is noted that the traffic information gathering methods used in those conventional traveler information services are often troubled by the following shortcomings: the amount of traffic information being generated and reported automatically are generally insufficient and unstable, the cost for the distribution and maintenance of fixed traffic monitors in large road networks can be very high, the coverage of GPS might not be in sufficient and inadequate since buses are limited to travel only on their designated routes and taxies are generally cursing within their familiar areas.

### TECHNICAL SUMMARY

In an exemplary embodiment, the present disclosure provides a traffic information notification method, that is adapted for a traffic information center and comprises the steps of:
receiving at least one journey data during an observation period while allowing each of the at least one journey data to at least include a travel time taken up to navigate through a predetermined route segment;
determining a prediction status based upon at least two journey data; and
updating a travel information based on the prediction status while broadcasting the updated traffic information.

In another exemplary embodiment, the present disclosure provides a traffic information notification method, that is adapted for a mobile device and comprises the steps of:
receiving a traffic information which at least includes: a maximum time and a minimum time required for navigating through the predetermined route segment;
generating a journey data which at least includes a travel time taken up to navigate through the predetermined route segment; and
issuing a report of the journey data if the travel time is small than the minimum time, or is larger than the maximum time.

In further another exemplary embodiment, the present disclosure provides a traffic information notification system, comprising:
a mobile device with global positioning and wireless transmission abilities; and
a traffic information center;
wherein, the mobile device is enabled to generate a journey data which at least includes a travel time taken up to navigate through a predetermined route segment; and the traffic information center is provided to receive the journey data during an observation period, and is enabled to determine a prediction status based upon at least two journey data; and then the traffic information center use the prediction status as base for generating and sending an updated traffic information to the mobile device.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a flow chart showing the steps of a traffic information notification method that are performed in a mobile device of the present disclosure.

FIG. 2 is a flow chart showing the steps of a traffic information notification method that are performed in a traffic information center of the present disclosure.

FIG. 3 is a block diagram showing a traffic information notification system according to an embodiment of the present disclosure.

### DESCRIPTION OF THE EXEMPLARY EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

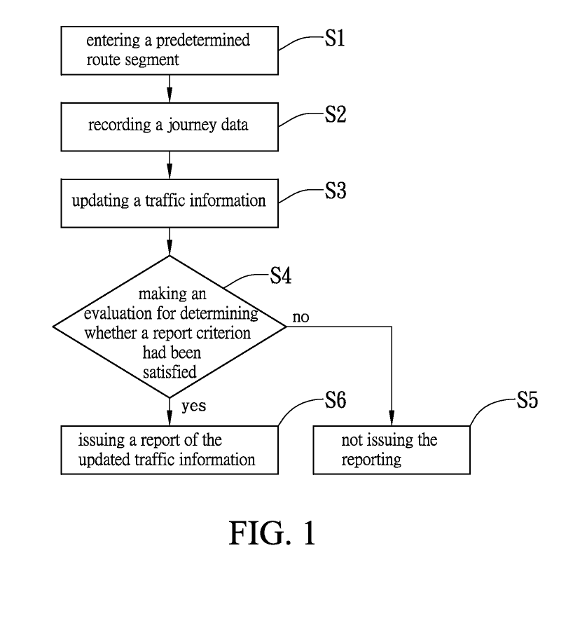

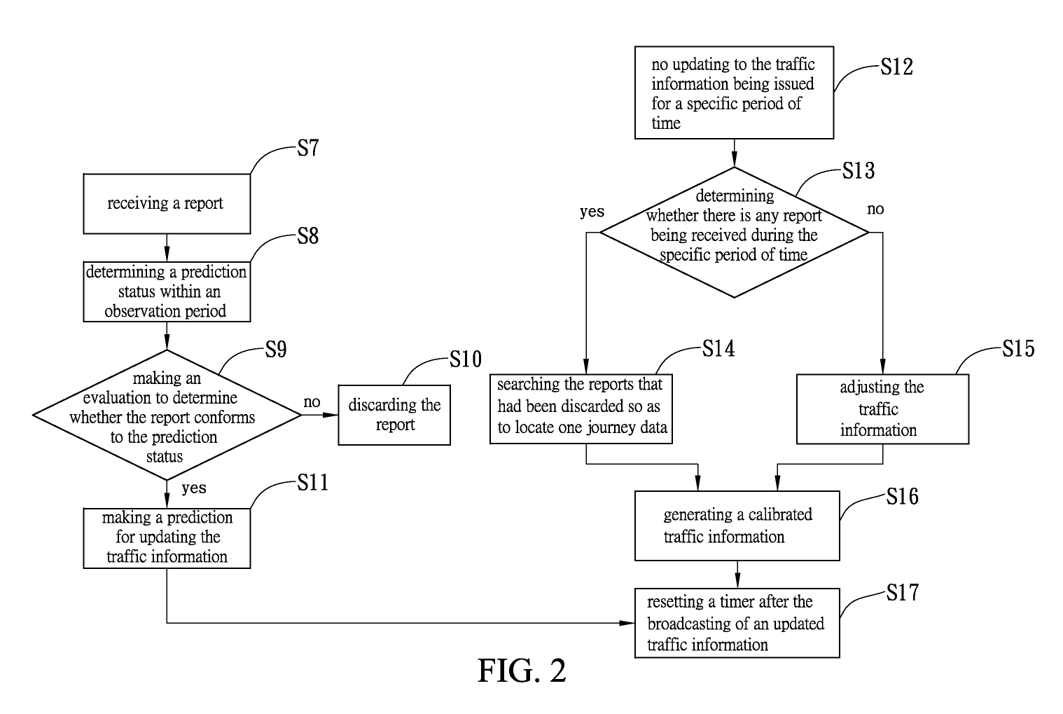

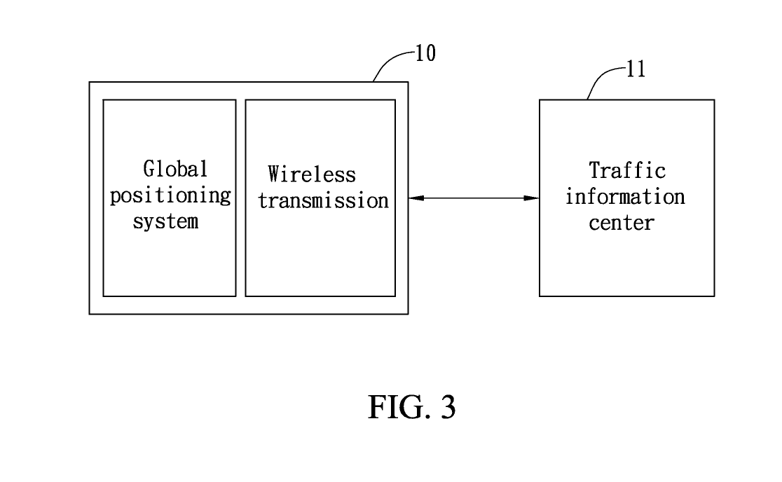

Please refer to FIG. 1 and FIG. 3, which are flow charts showing the steps of a traffic information notification method according to an embodiment of the present disclosure, and a block diagram showing a traffic information notification system according to an embodiment of the present disclosure. As shown in FIG. 1 to FIG. 3, the traffic information notification method comprising the steps of:
S1: as soon as a vehicle that is fitted with a mobile device 10 with GPS and wireless transmission abilities enters a specific route segment, the mobile device 10 which can be an intelligent mobile device such as a smart phone is enabled to receive a traffic information from a traffic information center 11, and the traffic information includes a maximum time and a minimum time required for navigating through the predetermined route segment. It is noted that the traffic information is provided to the mobile device 10 by the traffic information center 11 through a means selected from the group consisting of: a regional broadcast service and a wireless transmission means; the regional broadcast service is enabled to transmit an information containing a text, a pattern or a sound; the specific route segment is a continuous route; and there can be more than one such vehicle mounted with the mobile device 10.
S2: the mobile device 10 is activated to record a journey data of the vehicle when the vehicle is travelling on the specific route segment, whereas the journey data can include position information, driving speed and travelling time, and so on, and more particularly, the travelling time is the time taken up for the vehicle to navigating through the specific route segment.
S3: during the time when the vehicle is travelling on the specific route segment and before the vehicle exits the specific route segment, the mobile device 10 is ready to receive an updated traffic information from the traffic information center 11 at any time; and if there is no such update being broadcasted by the traffic information center 11, the original traffic information that is received by the mobile device at step S1 is still valid. It is noted that traffic information can initially include two historical data that are either randomly selected from the historical data stored in the traffic information center 11 that are travelling time taken up for the vehicle to navigating through the specific route segment, or the maximum time and minimum time historically used for the vehicle to navigating through the specific route segment.
S4: an evaluation is made for determining whether a report criterion had been satisfied, that is, when the travel time of the vehicle on the specific route segment is ranged between the minimum time and the maximum time, the report criterion is not satisfied and thus the flow proceeds to S5 for not issuing a report; otherwise when the travelling time is either larger than the maximum time or smaller than the minimum time, the report criterion is satisfied and thus the flow proceeds to S6 for issuing a report of the journey data to the traffic information center 11 to be used as base for updating and broadcasting the traffic information to all the mobile devices 10.
S7: the report from the mobile device 10 is received by the traffic information center 11 where it is stored.
S8: an observation period is defined by the traffic information center 11 and is used for determining a prediction status based upon the reported journey data that are received within the observation period. It is noted that the observation period can be a second or longer. In an embodiment, when the average of at least two successive journey data is larger than the average of the maximum time, the prediction status is set to be a rising status, indicating that there is a traffic jam; when the average of at least two successive journey data is smaller than the average of the minimum time, the prediction status is set to be a descending status, indicating that the traffic is smooth; and when the average of at least two successive journey data is ranged between the maximum and the minimum, the prediction status is set to be a stable status, indicating that the driving condition on the specific route segment is still normal.
S9: the prediction status is adopted if the latest journey data conforms to the prediction status that is determined by the step S8. In an embodiment, when the prediction status is set to be the rising status and the latest journey data shows that the travelling time is larger than the maximum time, the rising status is confirmed and thus is adopted; and when the prediction status is set to be the descending status and the latest journey data shows that the travelling time is smaller than the minimum time, the descending status is confirmed and thus is adopted. On the other hand, if the prediction status is set to be the rising status and the latest journey data shows that the travelling time is either smaller than the minimum time or is ranged between the maximum time and the minimum time, the rising status is proven to be incorrect and thus the report of the latest journey data is discarded, as shown in step S10.
S11: when the prediction status is being adopted, as indicated in step S9, the traffic information center 11 is enabled to make a prediction for updating the traffic information, and the same time, zeroing a timer after the broadcasting of the updated traffic information, as shown in step S17. By the zeroing of the timer, a new observation period of step S8 is initiated and the counting of the timer is started again, thereby, the flow can proceed back to step S7 at the end of the observation period.
S12: after step S4, when there is no updating to the traffic information for a specific period of time, the flow will proceed to step S13.
S13: an evaluation is made for determining whether there is any report being received during the specific period of time; if so, a search is performed upon the reports that had been discarded so as to locate one journey data, as indicated in step S14; otherwise, the traffic information is adjusted, as indicated in step S15. After locating a journey data from the discarded reports, the flow proceeds to step S16 for generating a calibrated traffic information according to either the maximum time or the minimum time in the located journey data, and then the flow can proceed to step S17 for broadcasting the calibrated traffic information to be used as an update to the traffic information while also zeroing the timer. The adjusting of the traffic information shown in step S16 is performed actually by adjusting the values of either the maximum time or the minimum time. For instance, in a condition when all the reports in the step S4 showed that the travelling times are mostly ranged between the maximum time and the minimum time, the traffic information center can determine that the range defined between the maximum time and the minimum time is too larges, which causes no report to be issued from the mobile devices 10 and received by the traffic information center 11. Therefore, it is reasonable for the traffic information center 11 to adjust either the maximum time or the minimum time for reducing the range defined between the maximum time and the minimum time. In an embodiment, the maximum time is reduced first, and then if there is still no report being received, the minimum is being increased; or the minimum time is increased first before reducing the maximum time. More particularly, it is possible to independently or simultaneously adjust the maximum time and/or the minimum time multiple times until a report is received. After the adjusting and a new report is received, the flow proceeds to step S16 for generating a calibrated traffic information according to the adjusting, and then the flow can proceed to step S17 for broadcasting the calibrated traffic information to be used as an update to the traffic information while also resetting the timer.

As shown in FIG. 3, the traffic information notification system comprises: a mobile device with global positioning and wireless transmission abilities; and traffic information center 11 with regional broadcasting and wireless transmission abilities.

In an embodiment, the mobile device 10 is mounted on a vehicle, which can be a survey vehicle, a private vehicle, a public transportation vehicle or a motorcycle, but is not limited thereby. Moreover, the mobile device 10 can be a handheld communication device, such as a smart phone, whichever is capable of generating a journey data by the executing of a program.

The traffic information center 11 is enabled to receive and store the journey data, and is designed to produce a traffic information to be transmitted to the mobile device 10 through a regional broadcasting means or a wireless transmission means. It is noted that the regional broadcast service is enabled to transmit an information containing a text, a pattern or a sound.

To sum up, in this disclosure, the journey data that is generated from the mobile device mounted on a vehicle is first compared with a traffic information broadcasted by a traffic information center, and then the comparison is used as base for determining whether or not the journey data is worthy to report back to the traffic information center. Further, by setting a threshold condition in the comparison, no all the journey data form each and every vehicle should be reported back to the traffic information center, and thus the working load of the traffic information center is reduced. Moreover, the driving condition of the specific route segment can be determined based upon the journey data and the current traffic information that is broadcasted by the traffic information center, and thus any variation in the driving condition can be detected and reported to the traffic information center, so that the traffic information center is able to issue an update to the traffic information to all the mobile device for notifying all the drivers with the latest driving condition on the specific route segment.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A traffic information notification method, adapted for a traffic information center, comprises the steps of:
receiving at least one journey data during an observation period while allowing each of the at least one journey data to include at least a travel time taken up to navigate through a predetermined route segment;
determining a prediction status based upon at least two journey data; and
updating a travel information based on the prediction status and broadcasting the updated traffic information.

2. The traffic information notification method of claim 1, wherein the traffic information includes: a maximum time and a minimum time required for navigating through the predetermined route segment.

3. The traffic information notification method of claim 2, wherein the prediction status is determined based upon the average of the at least two journey data, the average of the maximum time, and the average of the minimum time.

4. The traffic information notification method of claim 2, wherein the at least one journey data is received under a condition selected from the group consisting of:
the travel time is larger than the maximum time, and the travel time is smaller than the minimum time.

5. The traffic information notification method of claim 1, further comprising the step of:
generating a calibrated traffic information to be broadcast when there is no updating to the traffic information for a specific period of time.

6. The traffic information notification method of claim 5, wherein in the calibration traffic information, either the maximum time of the original traffic information is reduced, or the minimum time of the original traffic information is increased.

7. A traffic information notification method, adapted for a mobile device, comprises the steps of:
receiving a traffic information which at least includes: a maximum time and a minimum time required for navigating through the predetermined route segment;
generating a journey data which at least includes a travel time taken up to navigate through the predetermined route segment; and
issuing a report of the journey data if the travel time is smaller than the minimum time, or is larger than the maximum time.

8. The traffic information notification method of claim 7, further comprising the step of:
receiving an traffic information to be used for replacing the traffic information.

9. The traffic information notification method of claim 7, further comprising the step of:
discarding the issuing of the report when the travel time is ranged between the minimum time and the maximum time.

10. A traffic information notification system, comprising:
a mobile device with global positioning and wireless transmission abilities; and
a traffic information center;
wherein, the mobile device is enabled to generate a journey data which includes at least a travel time taken up to navigate through a predetermined route segment; and the traffic information center is provided to receive the journey data during an observation period, and is enabled to determine a prediction status based upon at least two journey data; and then the traffic information center use the prediction status as base for generating and sending an updated traffic information to the mobile device.

11. The traffic information notification system of claim 10, wherein the updated traffic information is provided to the mobile device by the traffic information center through a means selected from the group consisting of: a regional broadcast service and a wireless transmission means.

12. The traffic information notification system of claim 11, wherein the regional broadcast service is enabled to transmit an information containing a text, a pattern or a sound.
